(19) United States
(12) Patent Application Publication
(10) Pub. No.: US 2014/0180479 A1
(43) Pub. Date: Jun. 26, 2014

(54) Bagging With Robotic Arm

(71) Applicant: WAL-MART STORES, INC., Bentonville, AR (US)

(72) Inventors: Stuart Argue, Palo Alto, CA (US); Anthony Emile Marcar, San Francsico, CA (US)

(73) Assignee: Wal-Mart Stores, Inc., Bentonville, AR (US)

(21) Appl. No.: 13/723,147

(22) Filed: Dec. 20, 2012

(51) Int. Cl. B25J 13/08

(52) U.S. Cl. CPC B25J 13/08; Y10S 901/47
USPC 700/259; 901/47

(57) ABSTRACT

Systems and methods are disclosed for automatically or semi-automatically depositing retail items into a bag using a robotic arm. Embodiments of the present disclosure comprise a camera, an image processor, and a robotic arm control module to analyze and attempt to identify an item. Human intervention may be utilized to assist in item identification and/or robotic arm control. A human operator may visually identify the item and/or remotely control the robotic arm from a remote control station.

### BACKGROUND

A bottleneck in the checkout process at retail stores in many cases is the step of inserting purchased items into shopping bags. Bagging is typically a labor-intensive process that could slow down the shopping experience and decrease customer satisfaction. This bottleneck may be especially pronounced at grocery stores due to the large number of products purchased in a typical grocery retail transaction.

At many retailers, a single retail employee is responsible for scanning items, for entering transaction information in a register or like workstation, and for bagging the purchased items. At some retailers, the customer is expected to bag the purchased items after the retail employee has scanned them. Additional designated employees for bagging items may be cost-prohibitive to the retailer.

What is needed, therefore, is a system for automated or semi-automated bagging of purchased retail items.

### BRIEF DESCRIPTION OF THE DRAWINGS

Non-limiting and non-exhaustive embodiments of the present disclosure are described with reference to the following figures, wherein like reference numerals refer to like parts throughout the various views unless otherwise specified.

FIG. 1 is a block diagram representation of a robotic telebagging system according to embodiments of the present disclosure;

FIG. 2 is a depiction of a robotic telebagging system;

FIG. 3 is a flow chart illustration of an example method for placing an item into a bag using a robotic arm according to embodiments of the present disclosure;

FIG. 4 is an illustration of a remote control station interface for item identification according to an embodiment of the present disclosure; and

FIG. 5 is an illustration of a remote control station interface for robotic arm control according to an embodiment of the present disclosure.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present disclosure. Also, common but well-understood elements that are useful or necessary in a commercially feasible embodiment are often not depicted in order to facilitate a less obstructed view of these various embodiments of the present disclosure.

### DETAILED DESCRIPTION

In the following description, reference is made to the accompanying drawings that form a part thereof, and in which is shown by way of illustration specific exemplary embodiments in which the disclosure may be practiced. These embodiments are described in sufficient detail to enable those skilled in the art to practice the concepts disclosed herein, and it is to be understood that modifications to the various disclosed embodiments may be made, and other embodiments may be utilized, without departing from the spirit and scope of the present disclosure. The following detailed description is, therefore, not to be taken in a limiting sense.

Reference throughout this specification to “one embodiment,” “an embodiment,” “one example,” or “an example” means that a particular feature, structure, or characteristic described in connection with the embodiment or example is included in at least one embodiment of the present disclosure. Thus, appearances of the phrases “in one embodiment,” “in an embodiment,” “one example,” or “an example” in various places throughout this specification are not necessarily all referring to the same embodiment or example. Furthermore, the particular features, structures, or characteristics may be combined in any suitable combinations and/or sub-combinations in one or more embodiments or examples. In addition, it should be appreciated that the figures provided herewith are for explanation purposes to persons ordinarily skilled in the art and that the drawings are not necessarily drawn to scale.

Embodiments in accordance with the present disclosure may be embodied as an apparatus, method, or computer program product. Accordingly, the present disclosure may take the form of an entirely hardware-comprised embodiment, an entirely software-comprised embodiment (including firmware, resident software, micro-code, etc.), or an embodiment combining software and hardware aspects that may all generally be referred to herein as a “circuit,” “module,” or “system.” Furthermore, embodiments of the present disclosure may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present disclosure may be written in any combination of one or more programming languages. Such code may be compiled from source code to computer-readable assembly language or machine code suitable for the device or computer on which the code will be executed.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction and then scaled accordingly. A cloud model can be composed of various characteristics (e.g., on-demand self-service, broad network access, resource pooling, rapid elasticity, and measured service), service models (e.g., Software as a Service (“SaaS”), Platform as a Service (“PaaS”), and Infrastructure as a Service (“IaaS”)), and deployment models (e.g., private cloud, community cloud, public cloud, and hybrid cloud).

The flowchart and block diagrams in the attached figures illustrate the architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

Retail establishments generally strive to maximize profit. One way to increase a retailer's profits may be to increase customer transaction throughput at checkout stations while minimizing the retailer's labor force. Such an objective may be met by utilizing a robotic arm to bag purchased items at a checkout station. As described in the present disclosure, robotic arms may bag purchased retail items. The robotic arms may be controlled by a computer system having one or more cameras, a visual analysis module, and a remote control station. Such remote bagging may be referred to herein as “telebagging.”

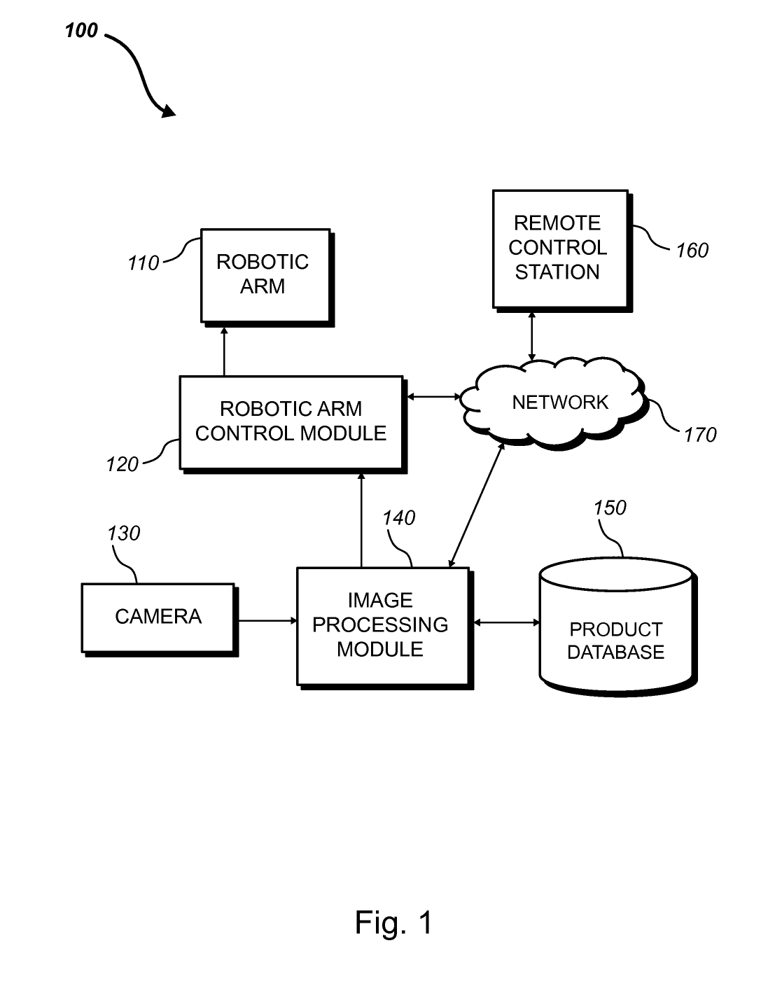

With reference to FIG. 1, a robotic telebagging system 100 embodiment of the present disclosure comprises robotic arm 110, robotic arm control module 120, camera 130, image processing module 140, product database 150, and remote control station 160.

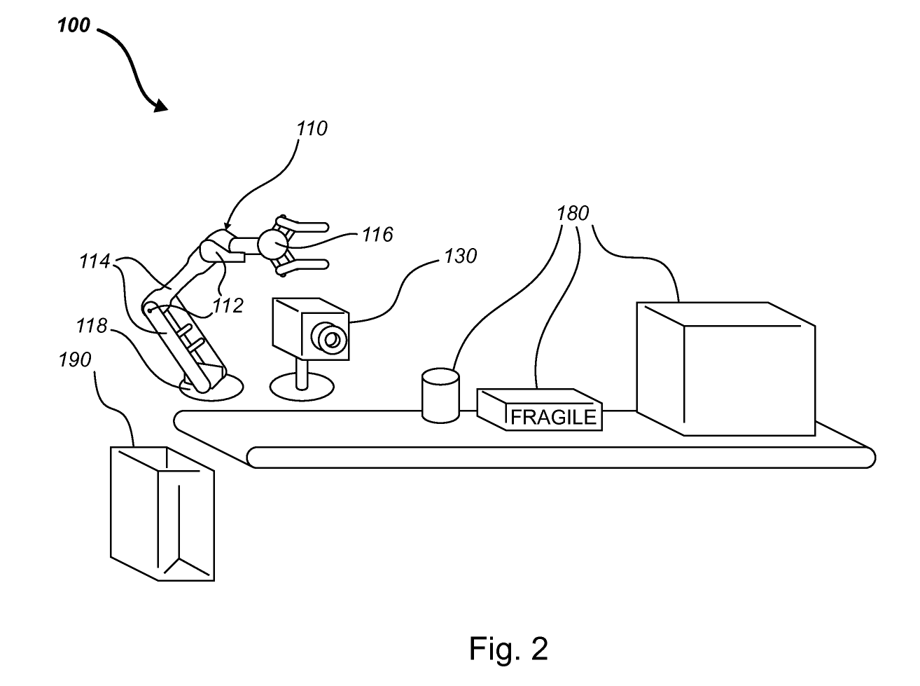

Referring to FIG. 2, robotic arm 110 comprises a mechanical arm having one or more joints 112 providing rotational motion, translation displacement, or both to one or more arm spans 114. Robotic arm 110 comprises gripper 116 at its extremity. Gripper 116 is adapted to grip selected objects and may be adapted to specifically grip objects sold in the retail store where the system 100 is installed. In embodiments, gripper 116 comprises rubber pads that may increase gripping ability of robot arm 110. In an embodiment, gripper 116 comprises pressure-sensing pads to provide feedback regarding gripping strength and prevent or mitigate damage to products and/or enhance gripping performance. Robotic arm 110 comprises robotic arm base 118. Base 118 is fastened to a checkout surface. In alternative embodiments, base 118 comprises a weighted base sufficiently heavy to mitigate tipping of robotic arm 110. In other embodiments of the present disclosure, robotic arm 110 comprises alternative pickup mechanisms as are known in the art.

Referring to FIGS. 1 and 2, robotic arm control module 120 is adapted to receive a signal representing one or more images captured by camera 130 and analyzed by image processing module 140. Robotic arm control module 120 comprises circuitry, a processor, and computer-readable instructions in the form of software stored in a memory, combinations thereof, or the like adapted to detect and/or identify objects in images captured by camera 130 as described herein. In an embodiment, robot arm control module 120 comprises circuitry, memory, and associated components that are installed within robotic arm base 118.

In embodiments, camera 130 comprises multiple cameras directed at various checkout station position and angles to capture any relevant views for the bagging process. In other embodiments, camera 130 comprises dual side-by-side image capturing apparatus to create a stereoscopic representation of a checkout station with retail items.

Image processing module 140 is adapted to receive images captured by camera 130 and identify retail products therein. Image processing module 140 is adapted to query product database 150 and/or receive product image data from product database 150 for the purpose of comparing images captured by camera 130 with images of retail products stored in product database 150. By comparing such images, image processing module 140 may identify any items captured by camera 130 and detect the spatial orientation of such items. In embodiments, image processing module 140 is adapted to analyze images captured by camera 130 and recognize certain identifying data from product packaging. For example, image processing module 140 may be adapted to identify bar codes on product packaging and query product database 150 for additional information about such identified products. As another example, image processing module 140 may be adapted to identify retail products by labeling or other aesthetic features of the product and/or packaging. In other embodiments, a scale at the checkout workstation is adapted to transmit data regarding a measured product weight to image processing module 140, which in turn may query product database 150 for a list of products having that approximate weight. Such a list of products may narrow down the number of possible products and thereby increase the likelihood of positive visual identification of products. In another embodiment, image processing module 140 has access to transaction data, for example from the transaction register, by which identification of purchased products may be made to assist image processing module 140 in item identification. In another embodiment, RFID chips embedded on or in item packaging may aid image processing module 140 in the product identification process.

In embodiments of the present disclosure, remote control station 160 comprises a computer workstation having a display and one or more input devices. Remote control station 160 is adapted to accept human inputs regarding a bagging process by a robotic arm 110 at a checkout workstation. In particular, remote control station 160 may be adapted to display images captured by camera 130 and accept control instructions for robotic arm 110. Input devices may include a keyboard, a computer mouse, a joystick, and the like. In embodiments, the display of remote control station 160 comprises a capacitive touchscreen panel. In alternative embodiments, the input devices of the remote control station 160 comprise a gesture input system, which may further comprise a glove-based gesture input system. Remote control station 160 may be located on premises at a retail store, or in a different building, a different city, or even a different country than robotic arm control module 120 and robotic arm 110. Remote control station 160 may be connected to robotic arm control module 120 through a network 170. In embodiments, network 170 comprises any communication network including, but not limited to: a wireless network, a cellular network, an intranet, the Internet, or combinations thereof.

In embodiments of the present disclosure, the checkout workstation comprises a conveyor belt that conveys purchased items from a checkout register toward the robotic arm 110. In alternative embodiments, the checkout workstation comprises ramp on which purchased items may slide down from a checkout register toward the robotic arm 110. In alternative embodiments, the checkout workstation comprises additional mechanical actuators or the like to position, orient, or otherwise manipulate purchased items. Such manipulation of purchased items may be aid robotic arm 110 in pickup of the items. Alternatively, manipulation of purchased items may be to place items in an area designated for manual bagging by a human associate.

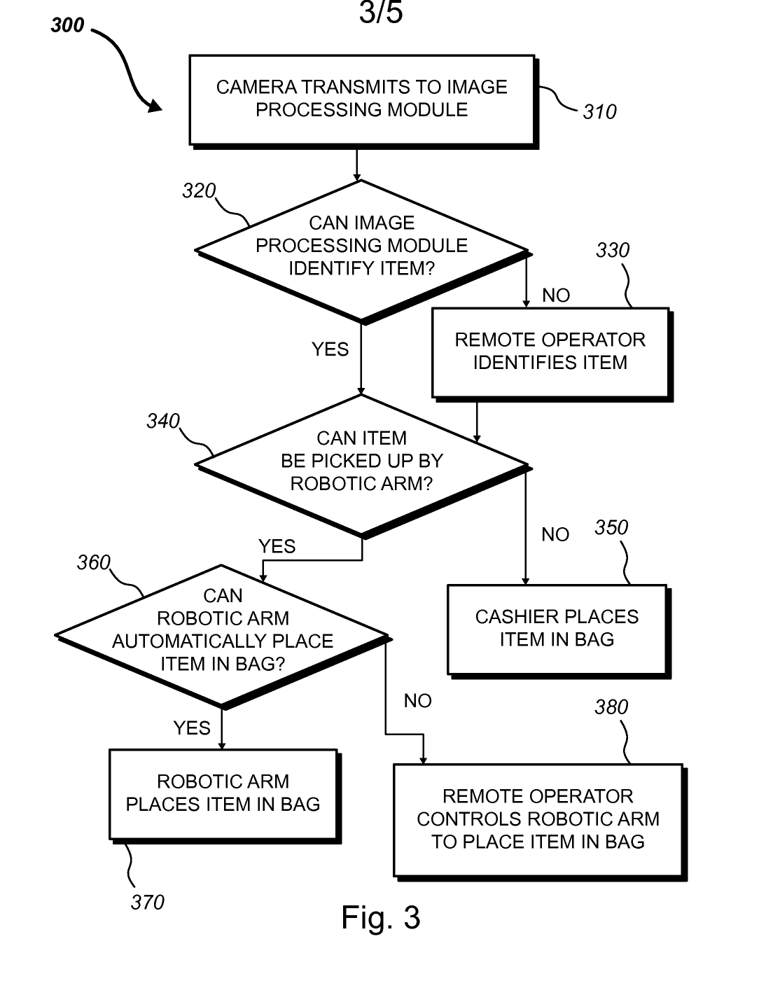

In operation, robotic telebagging system 100 is adapted to bag purchased retail items autonomously or semi-autonomously. Referring now to FIG. 3, embodiments of the present disclosure comprise method 300. At operation 310, camera 120 captures an image depicting an item that was purchased and transmits the image to image processing module 140.

At operation 320, image processing module 140 attempts to identify the purchased item at the checkout workstation. Image processing module 140 may analyze the product weight, transaction data, packaging shape, packaging size, packaging markings such as a UPC code or other specialized computer-readable marking, or other available information to identify the item. Such data may be queried at product database 150 in order to identify the item. Image processing module 140 may further detect the spatial orientation of the item to aid in guiding robotic arm 110 to pick up the object. In an embodiment, transaction data comprising product-identifying information, such as UPC numbers, is transmitted from a checkout register to image processing module 140. Accordingly, image processing module 140 may determine item identification from the set of purchased items identified in the transaction data. Items may be placed on the conveyer belt in the order that they were scanned by the retail associate. In embodiments, image processing module 140 may utilize transaction information to identify an item by correlating the item placement order on the conveyor belt to the order in which the items were processed in the transaction.

At operation 330, if image processing module 140 was unable to identify the retail item within a satisfactory confidence range, an image of the item may be transmitted to remote control station 160 for a human operator to view and identify the item. The human operator may be provided any additional data gathered by image processing module 140 to aid in the identification step.

At operation 340, the robotic arm control module 120 determines if the item is one that the robotic arm 110 is able to pick up and bag. Certain items that robotic arm 110 may not be able to pick up could include fragile items, bulky and/or heavy items, and large packaging. Data regarding items that cannot be picked up by robotic arm 110 may be stored in product database 150. If the robotic arm is unable to pick up an item, at operation 350, an alert condition may be created to notify a human cashier or other associate to pick up the item and deposit it into a bag. In alternative embodiments, the cashier's intervention may be limited to re-orienting the item on the conveyor belt in such a way that the robotic arm 110 may be able to pick up the item. In alternative embodiments, the cashier is trained to set items on the conveyor belt at a certain orientation to increase the likelihood that robotic arm 110 will successfully pick up each item. In other embodiments, the cashier is trained to set items on one of multiple conveyors, each of which leads to a different robotic arm 110 adapted to lift different types of packaging.

At operation 360, the robotic arm control module 120 determines if the item is one that the robotic arm 110 is able to bag without human guidance. If it is, at operation 370, the robotic arm control module 120 transmits control signals to robotic arm actuators to control the robotic arm 110 in picking up the item and depositing the item in a bag.

At operation 380, if robotic arm control module 120 determines that item is one that calls for human guidance, robotic arm control module 120 transmits a request to remote control station 160 for a human operator to control the robotic arm 110 to pick up the item and deposit the item in a bag. A video feed or image is transmitted to remote control station 160 and control is handed off to the human operator at remote control station 160 to control the robotic arm 110 in picking up the item and placing the item into a bag.

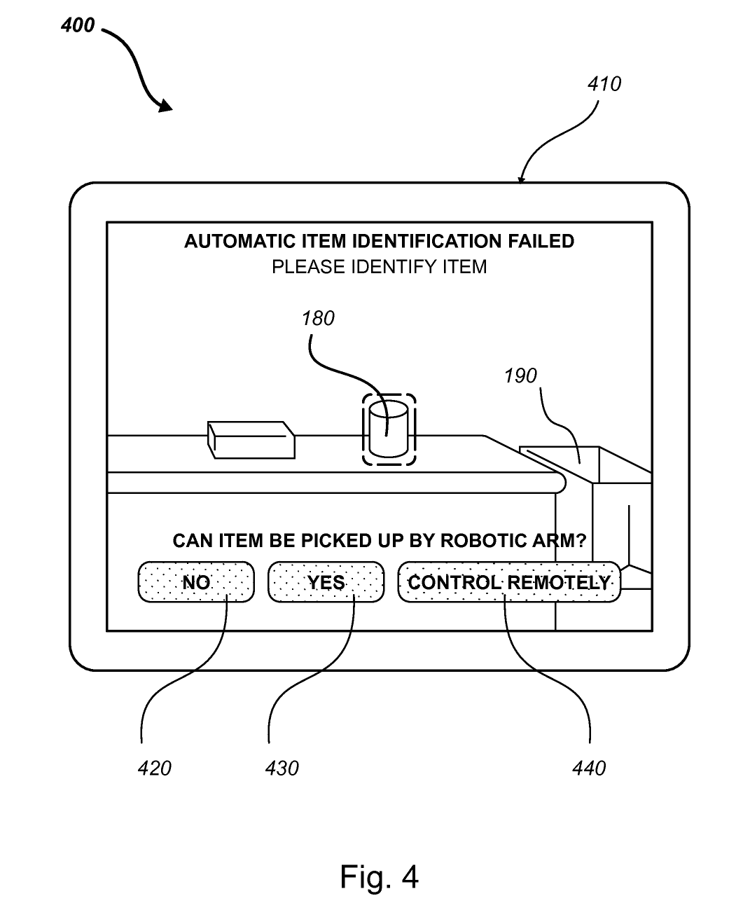

Referring now to FIG. 4, a remote control station 400 according to an embodiment of the present disclosure is depicted. Remote control station 400 comprises display 410. In embodiments, display 410 comprises a capacitive touch display, by which a human operator may make inputs. As depicted in FIG. 4, an image from camera 130 is reproduced on display 410. In this example, the image processing module 140 has failed to identify the item 180, so the human operator stationed at remote control station 400 is called upon to identify the item. As depicted in FIG. 4, the human operator may be requested to determine if the item is one that the robotic arm 110 may be able to pick up and/or place in bag 190. In alternative embodiments, the human operator may be asked to merely input a UPC or other product identifier after observing the item 180. The human operator may select NO object 420 if the robotic arm may be unable to pick up item 180. Alternatively, the human operator may select YES objet 430 if the robotic arm may be able to pick up item 180. Alternatively, the human operator may take control of robotic arm 110 by selecting CONTROL REMOTELY object 440.

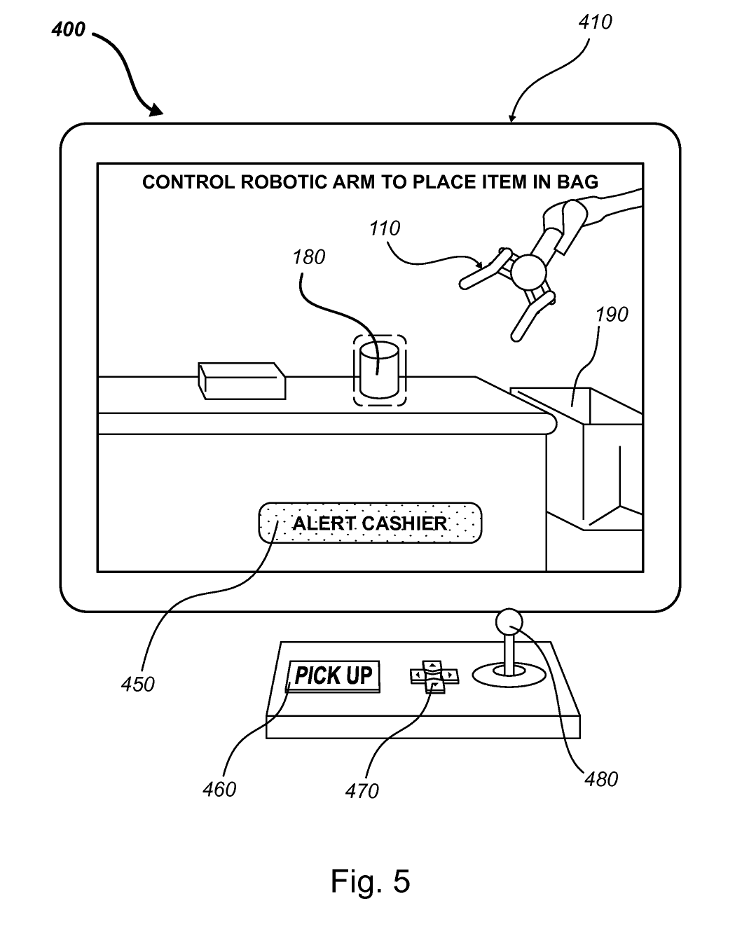

Referring now to FIG. 5, an image from camera 130 is displayed on display 410 of remote control station 400. The human operator is requested to control the robotic arm 110 to place the item 180 in bag 190. If a problem arises, the human operator may alert the cashier by selecting ALERT CASHIER object 450. The human operator may guide robotic arm 110 in picking up and depositing item 180 in bag 190 through robotic arm controls 460, 470, 480.

In alternate embodiments of the present disclosure, item packaging comprises certain visual indicators to assist image processing module 140 in identification of the package type and/or the orientation of the packaging to aid the robotic arm control module 120 to automatically pick up each item. In one embodiment, all or most product packaging comprises a standardized mark to indicate an acceptable orientation.

Embodiments of the present disclosure comprise a utilization optimization module, which is adapted to monitor certain wait-time indicators such as checkout line length or item bagging backlog to assign remote humans to the busiest checkout lines to optimize customer wait time and maximize utilization of the remote human operators. The utilization optimization module may compare wait-time indicators across multiple checkout aisles within one store, or may compare the wait-time indicators across any number of checkout aisles in any store worldwide. Accordingly, a human operator at remote control station 160 may be asked to assist robotic telebagging system 100 to bag items in any part of the world where the retailer has a presence. In alternative embodiments, robotic arms 110 are used for self-checkout aisles in retail stores to decrease wait time and bottlenecks.

In alternative embodiments, robotic arm control module 120 comprises algorithms to determine an ideal or preferred item bagging order. For example, robotic arm control module 120 may be programmed to place heavier items at the bottom of bags and to place eggs or other fragile items at the top of bags. Such algorithms may additionally be optimized to prevent overloading of bags.

Although the present disclosure is described in terms of certain preferred embodiments, other embodiments will be apparent to those of ordinary skill in the art, given the benefit of this disclosure, including embodiments that do not provide all of the benefits and features set forth herein, which are also within the scope of this disclosure. It is to be understood that other embodiments may be utilized, without departing from the spirit and scope of the present disclosure.

What is claimed is:

1. A method of bagging retail items comprising:
identifying a retail product at a retail checkout workstation;
transmitting a first signal that directs a robotic arm to pick up the retail product; and
transmitting a second signal that directs the robotic arm to deposit the retail product into a container.

2. The method of claim 1, wherein the container comprises a grocery bag.

3. The method of claim 1, further comprising capturing an image depicting the retail product.

4. The method of claim 3, further comprising transmitting the image to a remote control station.

5. The method of claim 4, further comprising receiving computer-readable instructions from the remote control station, wherein the computer-readable instructions direct a movement of the robotic arm.

6. The method of claim 4, further comprising receiving identification data from the remote control station.

7. The method of claim 3, wherein image is a stereoscopic image.

8. The method of claim 1, further comprising a remote control workstation comprising:
a display and
a controller input for controlling the robotic arm.

9. An apparatus for bagging items comprising:
a robotic arm at a retail checkout station;
at least one camera adapted to capture an image depicting a retail item; and
an image processing module adapted to analyze the image and transmit an image analysis result to a control module;
wherein the control module is adapted to transmit instructions to the robotic arm to pick up the retail item and deposit the retail item in a container.

10. The apparatus of claim 9, further comprising a remote control station whereat a human operator may input instructions for the robotic arm, wherein the remote control station is adapted to transmit instructions to the control module.

11. The apparatus of claim 9, wherein the container comprises a grocery bag.

12. The apparatus of claim 9, wherein image is a stereoscopic image.
